(19) United States
(12) Patent Application Publication
(10) Pub. No.: US 2019/0312826 A1
(43) Pub. Date: Oct. 10, 2019

(54) USER-SPECIFIC CANDIDATE RANKING FOR OUTBOUND MESSAGES

(71) Applicant: Apple Inc., Cupertino, CA (US)

(72) Inventors: Alkeshkumar M. Patel, San Jose, CA (US); Sherif Mohamed, Sunnyvale, CA (US)

(21) Appl. No.: 16/145,092

(22) Filed: Sep. 27, 2018

Related U.S. Application Data
(60) Provisional application No. 62/654,236, filed on Apr. 6, 2018.

(51) Int. Cl. H04L 12/58; G06F 3/0488

(52) U.S. Cl. CPC H04L 51/02; H04L 51/26; H04L 51/04; H04L 51/24; G06F 3/04883

(57) ABSTRACT

A device implementing a system for user-specific candidate responses includes a processor configured to determine candidate responses for a received message based at least in part on a determined category of the received message. The processor is further configured to rank the candidate responses based at least in part on input modalities utilized to input messages previously transmitted via the device, at least one of the previously transmitted messages comprising a respective at least one of the candidate responses. The processor is further configured to provide one or more of the ranked candidate responses for selection by a user.

### CROSS-REFERENCE TO RELATED APPLICATIONS

The present application claims the benefit of U.S. Provisional Patent Application Ser. No. 62/654,236, entitled “User-Specific Candidate Ranking for Outbound Messages,” filed on Apr. 6, 2018, which is hereby incorporated by reference in its entirety for all purposes.

### TECHNICAL FIELD

The present description relates generally to electronic messaging, including determining candidate responses to a received message.

### BACKGROUND

Electronic devices such as smartwatches, laptops, mobile phones, computers and mobile media devices may be used to participate in electronic messaging. For example, a user can generate a response to a message or compose a new message within an electronic messaging application, and transmit the response or new message to a recipient.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A-1B illustrate an example of an electronic device providing candidate responses to a user in accordance with one or more implementations.

FIG. 2 illustrates an example network environment including electronic devices that may rank candidate responses to a message in accordance with one or more implementations.

FIG. 3 illustrates an example electronic device that may implement a system for ranking candidate responses to a message in accordance with one or more implementations.

FIG. 4 illustrates an example of a candidate response ranker of the subject system that may be implemented by an electronic device in accordance with one or more implementations.

FIG. 5 illustrates a flow diagram of an example process for ranking candidate responses to a message in accordance with one or more implementations.

FIG. 6 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Although electronic messaging traditionally resided in the realm of computers and mobile phones, electronic messaging has since evolved to a more diverse array of devices, such as smartwatches, head-mounted displays, vehicles, and the like. Some of these devices may have constrained user input mechanisms relative to a computer or mobile phone. For example, a smartwatch may have a much smaller input screen than a computer or mobile phone while a vehicle may restrict user input while in motion. Accordingly, it may be desirable to facilitate the composition of outbound messages, for example, in devices that have constrained user input mechanisms.

In the subject system, an electronic device may receive a message, and provide a user with one or more candidate responses (e.g., user-selectable suggestions) for responding to the received message without having to type out, handwrite, or dictate a response. The subject system may rank the candidate responses based at least in part on information indicating user preferences with respect to prior outbound messages. For example, the information may indicate input modalities (e.g., dictation input, handwriting input, or suggested response selection input) used to generate the prior messages. In other examples, the information may indicate the frequency of selecting a prior suggested response, a length of prior message(s), and/or message content previously sent to a sender of the received message. Moreover, in one or more implementations such indicative information may be locally and exclusively stored on the electronic device, rather than being stored on a remote server.

By ranking the candidate responses based on information indicating user preferences with respect to prior outbound messages, the subject system may provide candidate responses that are more relevant to a user. In this manner, the user is more likely to select a candidate response, and thereby avoid having to type out, handwrite, or dictate a response. In addition, by storing the indicative information locally and exclusively on the electronic device, it is possible to maintain privacy of message content and user preferences with respect to electronic messaging. Accordingly, the subject system facilitates the composition of outbound messages (e.g., on an electronic device with constrained user input, such as a small screen) while maintaining privacy.

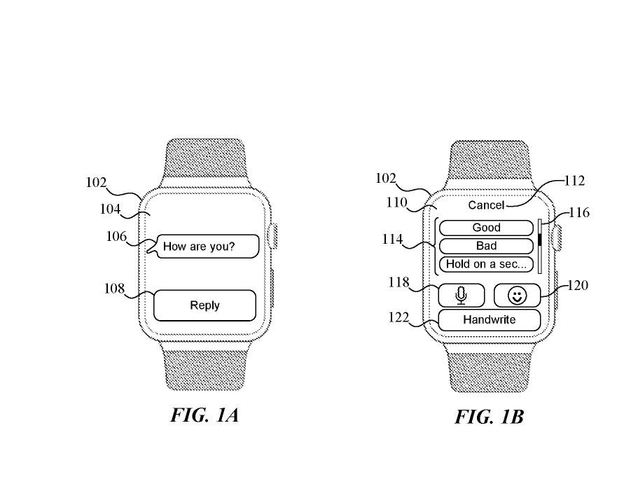

FIGS. 1A-1B illustrate an example of an electronic device providing candidate responses to a user in accordance with one or more implementations. Not all of the depicted components and/or user interface may be used in all implementations, however, and one or more implementations may include additional or different components and/or user interfaces than those shown in FIGS. 1A-1B. Variations in the arrangement and type of the components and/or user interfaces may be made without departing from the spirit or scope of the claims as set forth herein. Additional components and/or user interfaces, different components and/or user interfaces, or fewer components and/or user interfaces may be provided.

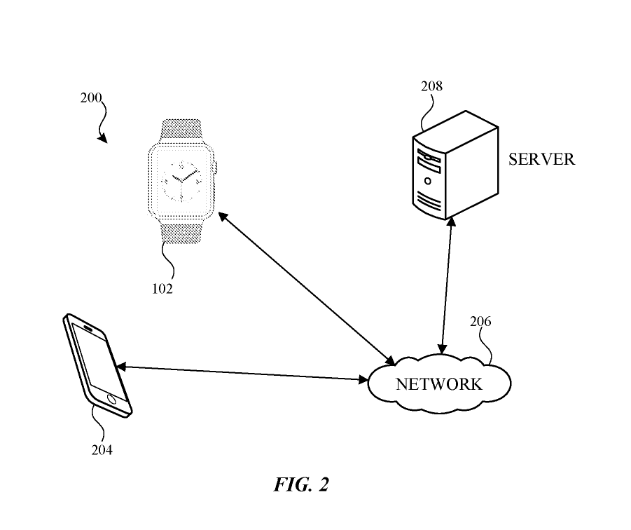

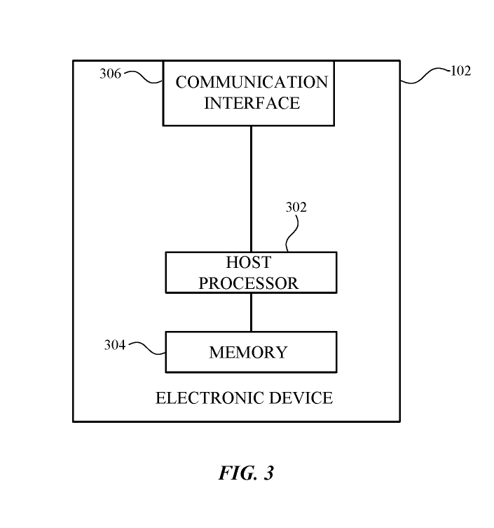

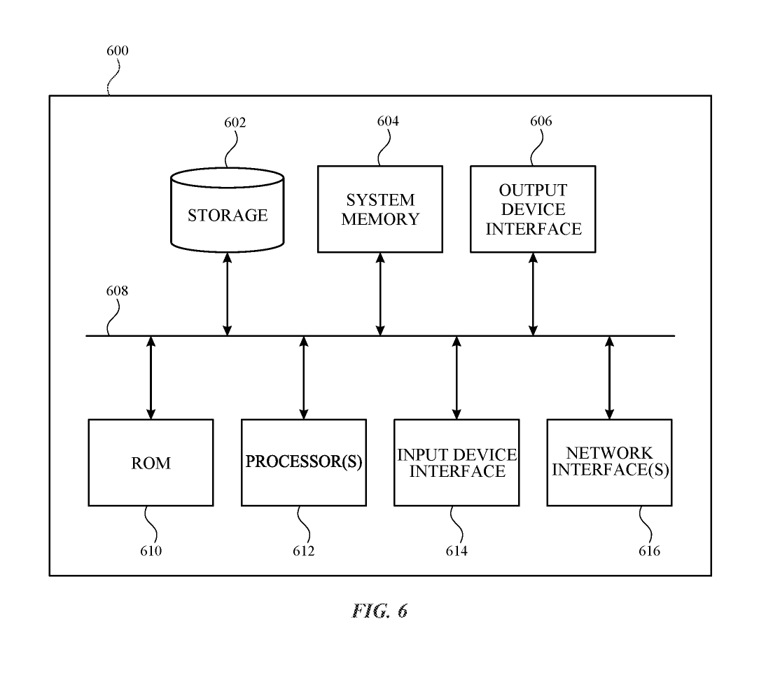

By way of example, the electronic device 102 of FIGS. 1A-1B is depicted as a smartwatch. The electronic device 102 may be, and/or may include all or part of, the electronic devices discussed below with respect to FIGS. 2-3, and/or the electronic system discussed below with respect to FIG. 6.

FIG. 1A illustrates an example user interface 104 provided by the electronic device 102 upon receipt of a message. The user interface 104 includes a received message component 106. For example, the received message component 106 may correspond to a message received from another device. The user interface 104 further includes a reply button 108 for responding to the received message.

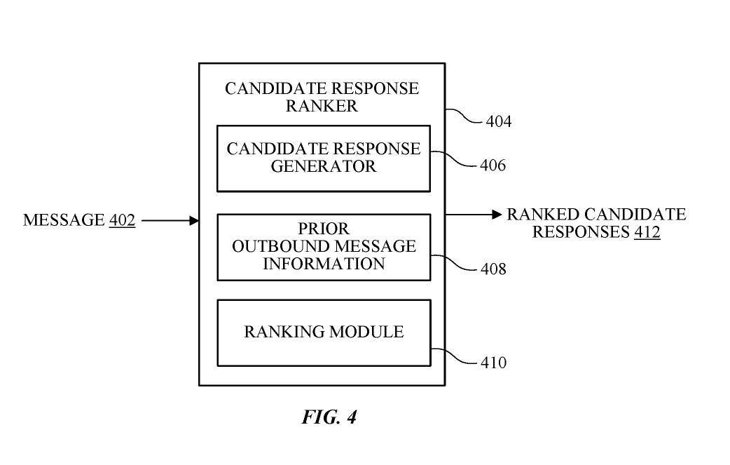

In the example of FIG. 1, the user interface 104 may correspond to a screen in a messaging application, where the messaging application may be one or more of an instant messaging application, an email application, a text message application, or another type of application which provides for electronic messaging between devices. However, as discussed below with respect to FIG. 4, indication of a received message may also be provided as a notification screen within a different application, for example, as an overlay within with other application. Such indication of the received message may include user interface components similar to the received message component 106 and the reply button 108, but presented (e.g., formatted) as an overlay.

FIG. 1B illustrates an example user interface 110 provided by the electronic device 102 upon user selection of the reply button 108 of the user interface 104 of FIG. 1A. The user interface 110 may present options for replying to the received message. The user interface 110 may include a cancel button 112 which, if selected, provides for canceling a reply to the received message and returning to the user interface 104.

In addition, the user interface 110 may include a dictation button 118 which, if selected, provides for the user to dictate a response message. The user interface may further include a handwriting button 122 which, if selected, provides for the user to handwrite (e.g., scribble) a response message. The user interface may further include an image button 120, which if selected, provides for the user to respond using predefined images and/or emoji icons.

In addition, the user interface may include candidate response button(s) 114, each of which corresponds to a user-selectable candidate response for responding to the received message. In one or more implementations, the candidate response button(s) 114 may be scrollable via a scrollbar 116. For example, additional one(s) of the candidate response(s) button(s) may be presented to the user by swiping the scrollbar 116, in a case where some candidate response(s) are not initially displayed within the user interface 110. Moreover, the order and display of the candidate response button(s) may be based on a ranking of the candidate response(s), as discussed further below with respect to FIGS. 2-5, such that the user may select an appropriate candidate response with minimal interaction with the electronic device 102.

FIG. 2 illustrates an example network environment 200 including electronic devices that may rank candidate responses to a message in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 200 includes electronic devices 102 and 204 (hereinafter 102, 204), and a server 208. The network 206 may communicatively (directly or indirectly) couple, for example, any two or more of the electronic devices 102, 204 and/or the server 208. In one or more implementations, the network 206 may be an interconnected network of devices that may include, or may be communicatively coupled to, the Internet. For explanatory purposes, the network environment 200 is illustrated in FIG. 2 as including electronic devices 102, 204 and a single server 208; however, the network environment 200 may include any number of electronic devices and any number of servers.

One or more of the electronic devices 102, 204 may be, for example, a portable computing device such as a laptop computer, a smartphone, a peripheral device (e.g., a digital camera, headphones), a tablet device, a wearable device such as a smartwatch, a band, a head-mounted display, and the like, a car radio or head unit, or any other appropriate device that includes, for example, one or more wireless interfaces, such as WLAN radios, cellular radios, Bluetooth radios, Zigbee radios, near field communication (NFC) radios, and/or other wireless radios. In FIG. 2, by way of example, the electronic device 102 corresponds to the smartwatch depicted in FIGS. 1A-1B, and the electronic device 204 is depicted as a smartphone. Each of electronic devices 102, 204 may be, and/or may include all or part of, the electronic device discussed below with respect to FIG. 3, and/or the electronic system discussed below with respect to FIG. 6.

The server 208 may be, and/or may include all or part of the electronic system discussed below with respect to FIG. 6. The server 208 may include one or more servers, such as a cloud of servers, that may be used in a system for electronic messaging. For example, a first user of the electronic device 102 may receive a message sent by a second user of the electronic device 204. The transmission of the message from the electronic device 204 to the electronic device 102 may be facilitated by the network 206 and/or the server 208.

The electronic device 102 may further determine and rank candidate responses for responding to the received message. In addition, the electronic device 102 may present the first user with the ranked candidate responses (e.g., as candidate response buttons 114). Upon the first user selecting one of the candidate responses, the electronic device 102 may transmit the selected candidate response to the electronic device 204 of the second user via the network 206 and/or the server 208.

FIG. 3 illustrates an example electronic device that may implement a system for ranking candidate responses to a message in accordance with one or more implementations. For example, electronic device 102 can correspond to the electronic device 102 from FIGS. 1A-1B and FIG. 2. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 102 may include a host processor 302, a memory 304, and a communication interface 306. The host processor 302 may include suitable logic, circuitry, and/or code that enables processing data and/or controlling operations of the electronic device 102. In this regard, the host processor 302 may be enabled to provide control signals to various other components of the electronic device 102. The host processor 302 may also control transfers of data between various portions of the electronic device 102. Additionally, the host processor 302 may enable implementation of an operating system or otherwise execute code to manage operations of the electronic device 102. In the subject system, the host processor 302 may implement the software architecture for generating candidate responses to a message, which is discussed further below with respect to FIG. 4.

The memory 304 may include suitable logic, circuitry, and/or code that enable storage of various types of information such as received data, generated data, code, and/or configuration information. The memory 304 may include, for example, random access memory (RAM), read-only memory (ROM), flash, and/or magnetic storage. In one or more implementations, the memory 304 may store a data structure which includes information indicative of user preferences with respect to prior outbound messages. For example, the data structure may correspond to prior outbound message information, discussed further below with respect to FIG. 4.

The communication interface 306 may include suitable logic, circuitry, and/or code that enables wired or wireless communication, such as between any of the electronic devices 102, 204 and server 208 over the network 206. The communication interface 306 may include, for example, one or more of a Bluetooth communication interface, an NFC interface, a Zigbee communication interface, a WLAN communication interface, a USB communication interface, or generally any communication interface.

In one or more implementations, one or more of the host processor 302, the memory 304, the communication interface 306, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 4 illustrates an example of a candidate response ranker of the subject system that may be implemented by an electronic device in accordance with one or more implementations. For example, the candidate response ranker 400 can be implemented by one or more software modules running on the host processor 302 of the electronic device 102 of FIGS. 1A-1B and 2. In another example, the candidate response ranker 400 can be implemented by custom hardware (e.g., one or more coprocessors) configured to execute the functionality of the candidate response ranker 400. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As noted above, it may be desirable to facilitate the composition of outbound messages, for example, in wearable devices which have constrained user input mechanisms, such as limited screen space. The most convenient manner for responding to a received message (e.g., with the least amount of user interaction) may be a selection of a candidate response. However, if the candidate responses are not relevant or appropriate, then the user may move on to typing, handwriting, or dictating a response, each of which may be less convenient (e.g., require more user interaction) than selecting a candidate response. The candidate response ranker 404 of the subject system may improve this experience by, for example, providing candidate responses that are more relevant and/or useful, and presenting the candidate responses in a manner that reduces user interaction time. By ranking and sorting candidate responses by relevance specific to the user, the user is less likely to need to scroll (e.g., via scrollbar 116) to find an appropriate response, and less likely to need to resort to typing, handwriting, or dictating an appropriate response.

In one or more implementations, the candidate response ranker 404 implements a machine-learning based strategy for learning the user preferred responses on the electronic device 102. Moreover, user privacy may be maintained, for example, by storing information indicative of the user preferred responses locally and exclusively on the electronic device 102, e.g., without storing the information on a server or other device.

As shown in FIG. 4, the candidate response ranker 404 includes a candidate response generator 406, prior outbound message information 408 and a ranking module 410. The candidate response ranker 404 may receive a message 402 received at the electronic device 102 as input, and provide ranked candidate responses 412 as output.

In one or more implementations, the message 402 corresponds to a message from the electronic device 204 to the electronic device 102. As noted above, for example, a first user of the electronic device 102 may receive the message 402 sent by the second user of the electronic device 204. The message 402 may have been sent from the electronic device 204 to the electronic device 102 via a messaging application (e.g., an instant messaging, an email application, a text message application) running on one or more of the electronic devices 102, 204. In addition, the respective messaging applications may work in conjunction with the network 206 and/or the server 208 to facilitate the transmission of messages between the electronic devices 102 and 204.

The candidate response generator 406 may generate an initial set of candidate responses for the message 402 based on a determined category of the received message. For example, a received message of “how are you?” may correspond to a first category of received messages, with candidate responses such as “good,” “bad” and/or “hold on a sec . . . ” On the other hand, a received message of “are you on time?” may correspond to a second category of received messages, with candidate responses such as “yes,” “no” and/or “hold on a sec . . . ”

In one or more implementations, determining the category of the received message may be based on an algorithm which associates received messages with respective categories, such as based on a context of the received message as determined by, for example, a semantic analysis of the content of the received message. In one or more implementations, the category of a received message may be determined using a machine learning based classifier. The machine learning based classifier can be a rule-based classifier that checks for linguistic patterns and rules, and/or a data-driven statistical classifier trained with supervised data.

For example, the rule-based classifier may check for the presence of keywords (e.g., “when,” “how,” “how many” and the like) and underlying part-of-speech/lemma information (e.g., verb, noun, adverb, and the like). In addition, the rule-based classifier may apply a preset rule(s) if a given message corresponds to a predefined category (e.g., polar, evaluative, appreciation, apology, etc.). For example, a message “how are you?” includes the keyword “how” followed by a verb with the lemma “be,” and may be classified as an evaluative message.

In another example, the data-driven statistical classifier may be based on machine learning algorithms such as, but not limited to, logistic regression, support vector machines (SVM), neural networks, and the like, and may be trained based on annotated data (e.g., a message with its class labels).

For each of the categories, a predefined, base-level list of candidate responses may initially be considered by the electronic device 102. These candidate responses may be modified based on the ranking performed in association with the candidate response ranker 404.

The prior outbound message information 408 (e.g., stored in memory 304) may include information indicative of user preferences with respect to prior outbound messages. In one or more implementations, each time the user sends a message via the electronic device 102, the candidate response ranker 404 may update the prior outbound message information 408 with one or more of the following information items: the recipient identifier (ID) (e.g., a phone number or email) the user is sending the message to; the language of the conversation; the content of (or an identifier of) the message the user is responding to, if applicable; the input modality used by the user for the outbound message (e.g., handwriting, dictation, selected response), and whether the outbound message was generated via the messaging application or via notification (e.g., an overlay presented within another application). Moreover, if the user selected one of the candidate responses, the prior outbound message information 408 may further include the list of candidate responses that were presented to the user for the prior message (e.g., for additional context). In one or more implementations, the prior outbound message information 408 may include an indication of the ranking of the selected candidate response and/or an indication of whether the user needed to scroll to access the selected candidate response.

In one or more implementations, the prior outbound message information 408 may be stored locally and exclusively on the electronic device 102. Alternatively or in addition, it is possible for the prior outbound message information 408 to be shared with other electronic devices associated with a user. For example, the user of a wearable device (e.g., a smartwatch) may wish to have his/her preferences accessible by other devices (e.g., a head-mounted display, a car radio or head unit) associated with an account of the user. The user may be provided with an option to access the personalized ranking information (e.g., corresponding to the candidate response ranker 404) from one or more of those other devices.

From the prior outbound message information 408, the candidate response ranker 404 may be able to determine one or more of: the input modalities utilized to input messages previously transmitted via the device, whether previously-transmitted messages were a reply to a notification or a newly-composed message, the frequency of selecting prior suggested responses, the lengths of prior message(s), the ranking or selected candidate responses, and/or message content previously sent to the sender of the received message. In this regard, the ranking module 410 may be used to rank the candidate responses based on one or more of these parameters.

For example, if the user typically responds with “Yeah” instead of “Yes,” the ranking module 410 may rank the candidate response “Yeah” higher on the list of replies than “Yes.” As such, user input provided via typewriting, handwriting, or dictation, may be used to generate and rank candidate responses. Thus, based on user input via typewriting, handwriting, or dictation and/or user selection of prior candidate responses, the candidate responses for a current message may be ranked so that the preferred responses are in a top position of the user interface 110. In this manner, the user effort may be reduced by not requiring the user to dictate (e.g., via the dictation button 118), handwrite (e.g., via the handwriting button 122), or scroll (e.g., via scrollbar 116) for a preferred response.

Moreover, the ranking module 410 may rank candidate responses based on the intended recipient of an outbound message (e.g., the sender of the received message). For example, a user may develop his/her own writing style when messaging with friends as opposed to work colleagues. In other words, the user may be more likely to handwrite and/or dictate a custom message than try to find a default candidate response message that matches his/her style of communication. Moreover, that style may change depending on the recipient. For example, a response to a business-related message might be more formal in style than a casual response to a friend. Thus, the ranking module 410 may supplement default candidate responses with custom responses on a per-recipient basis, such as based on responses that were typed, handwritten, and/or dictated by the user.

In one or more implementations, the ranking module 410 may rank candidate responses across multiple languages. For example, a user (e.g., a multilingual user) may send and/or receive messages in different languages. As noted above, the prior outbound message information 408 may indicate the language for each prior outbound message in a conversation. Thus, the candidate response ranker 404 may identify the language for a received message (e.g., based on the message conversation, metadata of the received message, and/or on analyzing the received message in view of a user's known languages), and rank candidate responses based on the prior outbound message information 408 that matches the language of the received message.

Thus, the ranking module 410 implements a ranking mechanism that uses candidate response heuristics to build a more context-relevant set of candidate responses, such as based on the message recipient. Once a ranking function is established, at runtime, given a message and a recipient, the ranking module 410 can evaluate the scores of each candidate response and present them according to their score.

In one or more implementations, the ranking module 410 tracks the following user metrics, or counts, with respect to candidate responses: the number of times the user has selected a response for a given category of message (N_{selected}^{(r,c)}); the number of times the selected response was selected from within the messaging application (N_{source_app}^{r}), e.g., where the messaging application corresponds to instant messaging, email application, text messaging application; the number of times the selected response was selected through notification (N_{source_notification}^{r}); e.g., as an overlay on top of an application separate from the messaging application; the number of times the selected response was input by selecting from the list of candidate responses (N_{input_canned}^{r}); the number of times the selected response was input through handwriting (N_{input_scribble}^{r}); the number of times the selected response was input through dictation (N_{input_dictation}^{r}); the number of times the selected response was selected for the same recipient (N_{same_recipient}^{r}); and/or the length of selected response (l^{r}).

In one or more implementations, the ranking module 410 may implement a time decay function with respect to one or more of the above-noted metrics. For example, counts may be bound to decay since user preferences may change over a period of time. In this regard, the ranking module 410 may set a time period to be t days, which corresponds to the number of days elapsed since the last time user selected a given response. The ranking module 410 may implement the exponential decay function, e.g., e^{-λt}.

In one or more implementations, the ranking module 410 may provide a higher preference to a response if it is for the same recipient. However, since counts per recipient may generally be sparse (e.g., based on a threshold value), the ranking module 410 may simply use counts across all recipients. In one or more implementations, the candidate response ranker may account for a response being for the same recipient into the overall ranking function.

In one or more implementations, the ranking module 410 may employ the following equation as part of its ranking:

$$Rank ( r , c , t ) = α * {N}_{selected}^{( r , c )} * {e}^{- λ t} + [ β * {N}_{{source}_{app}}^{{r}^{′}} + ( 1 - β ) * {N}_{{source}_{notification}}^{{r}^{′}} ] * {e}^{- λ t} + ( γ 1 * {N}_{input \_ canned}^{{r}^{′}} + γ 2 * {N}_{input \_ scribble}^{{r}^{′}} + γ 3 * {N}_{input \_ dictation}^{{r}^{′}} ) * {e}^{- λ t} + δ * {N}_{same \_ recipient}^{r} * {e}^{- λ t} + θ * \frac{1}{\sqrt{{l}^{r}}} \qquad [ Equation 1 ]$$

In Equation 1, the parameters may be defined as follows:

$${N}_{{source}_{app}}^{{r}^{′}} = \frac{{N}_{{source}_{app}}^{r}}{{N}_{{source}_{app}}^{r} + {N}_{{source}_{notification}}^{r}}$$

$${N}_{{source}_{notification}}^{{r}^{′}} = \frac{{N}_{{source}_{notification}}^{r}}{{N}_{{source}_{app}}^{r} + {N}_{{source}_{notification}}^{r}}$$

$${N}_{{input}_{canned}}^{{r}^{′}} = \frac{{N}_{{sinput}_{canned}}^{r}}{{N}_{{input}_{canned}}^{r} + {N}_{{input}_{scribble}}^{r} + {N}_{{input}_{dictation}}^{r}}$$

$${N}_{{input}_{scribble}}^{{r}^{′}} = \frac{{N}_{{input}_{scribble}}^{r}}{{N}_{{input}_{canned}}^{r} + {N}_{{input}_{scribble}}^{r} + {N}_{{input}_{dictation}}^{r}}$$

$${N}_{input \_ dictation}^{{r}^{′}} = \frac{{N}_{input \_ dictation}^{r}}{{N}_{input \_ canned}^{r} + {N}_{input \_ scribble}^{r} + {N}_{input \_ dictation}^{r}}$$

Moreover, in Equation 1,

$$λ = \frac{1}{T} ,$$

where T is a maximum number of days after which respective count diminishes. In addition the constants may be constrained such that: 0≤α≤1; 0≤β≤1; γ1+γ2+γ3=1; 0≤δ≤1; and 0≤θ≤1.

As noted above, the ranking module 410 may employ a machine-learning model for training and inference. In this regard, the above-listed parameters in the ranking function may be different for different users. For example, the parameters can be learned on a per-device basis, by periodically training or retraining the machine learning model. The data for training may be collected based on the outbound messages sent from the electronic device 102, and stored on the electronic device 102 (e.g., in association with the prior outbound message data). To reduce user impact, the training process may initiate during a time when the electronic device 102 is idle (e.g., while the electronic device 102 is charging). The training process updates the above-listed parameters which can be used at runtime during inference.

The above information, the counts from stored on-device data, and the learned parameters are used for evaluation of the ranking function to generate the final score. Thus, the candidate responses are ranked according to their score and presented for display to the user on the electronic device 102, as ranked candidate responses 412.

The ranked candidate responses 412 may be displayed within the user interface 104. For example, the ranked candidate responses may be presented as the candidate response buttons 114. Upon the first user selecting one of the candidate responses, the electronic device 102 may transmit the selected candidate response to electronic device 204 of the second user (e.g., as a response to a message received from the second user).

While the above-described examples may relate to tracking outbound messages corresponding to text, the candidate response ranker 404 is not limited to such. For example, the candidate response ranker 404 may store data associated other types of message content, and rank candidate responses based on the content. Such content may include, but is not limited to, images (e.g., in association with image button 120), videos, and/or map data (e.g., a selected location on a map). In addition, the candidate response ranker 404 may also store data associated with, e.g., bubble effects, screen effects, and/or other features that may impact the display of a received message.

Moreover, while the above-described examples relate to providing candidate responses for a specific user and/or device, the candidate response ranker 404 is not limited to such. For example, the candidate response ranker 404 may be implemented on multiple devices corresponding to multiple users. The multiple devices may store user preference data (e.g., in an anonymous manner) in aggregate on the server 208, and this data may be used to determine crowd-sourced candidate response(s). For example, the crowd-sourced, candidate responses may accommodate the preferences shared by multiple users.

By ranking candidate responses as described herein, it is possible to facilitate composition of outbound messages, for example, for electronic devices with limited resources, such as wearable devices. Wearable devices may have limited disk and memory storage relative to other electronic devices (e.g., smartphones, laptops). Further, a wearable device may not have the processing power to perform more intensive training on the device. Moreover, using the subject system, it is possible to learn user preferred responses on the electronic device 102 and rank them effectively. Such ranking may work with sparse data, may minimize the disk footprint, and may result in reduced processing and/or power consumption of the electronic device 102.

In one or more implementations, one or more of the candidate response ranker 404, including the candidate response generator 406, the prior outbound message information 408 and the ranking module 410, are implemented as software instructions, stored in the memory 304, which when executed by the host processor 302, cause the host processor 302 to perform particular function(s).

In one or more implementations, one or more of candidate response ranker 404, including the candidate response generator 406, the prior outbound message information 408 and the ranking module 410, may be implemented in software (e.g., subroutines and code) and/or hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. In one or more implementations, some or all of the depicted components may share hardware and/or circuitry, and/or one or more of the depicted components may utilize dedicated hardware and/or circuitry. Additional features and functions of these modules according to various aspects of the subject technology are further described in the present disclosure.

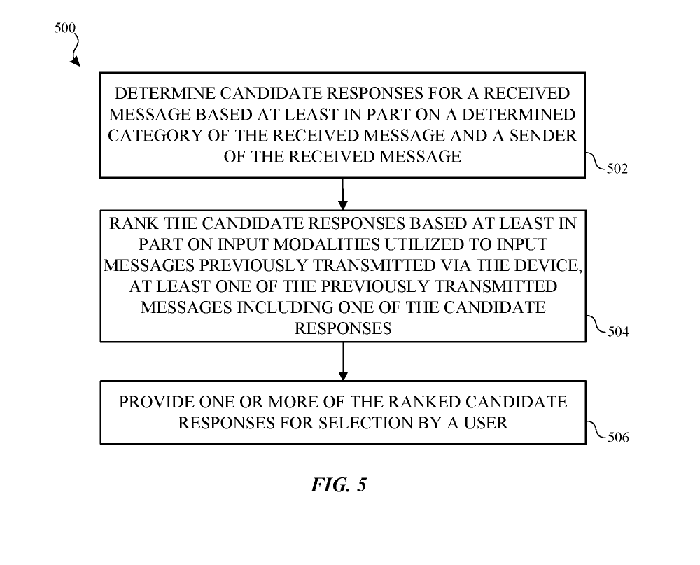

FIG. 5 illustrates a flow diagram of an example process for ranking candidate responses to a message in accordance with one or more implementations. For explanatory purposes, the process 500 is primarily described herein with reference to the electronic device 102 of FIGS. 1A-1B and FIG. 2. However, the process 500 is not limited to the electronic device 102, and one or more blocks (or operations) of the process 500 may be performed by one or more other components of the electronic device 102 and/or by other suitable devices (e.g., the electronic device 204). Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

The electronic device 102 determines candidate responses for a received message based at least in part on a determined category of the received message (502). The electronic device 102 ranks the candidate responses based at least in part on input modalities utilized to input messages previously transmitted via the electronic device 102, at least one of the previously transmitted messages including one of the candidate responses (504).

In one or more implementations, the input modalities may include at least one of: a dictation input mode, a handwriting input mode, or a suggested response selection input mode. Information indicative of the input modalities utilized to input messages previously transmitted via the device may be stored exclusively on the device. In one or more implementations, ranking the candidate responses may be further based at least in part on respective frequencies of user selection of the candidate responses in the suggested response selection input mode. This ranking may be biased with respect to the respective frequencies based on a time decay function.

In one or more implementations, ranking the candidate responses may be further based at least in part on a sender of the received message (e.g., corresponding to the intended recipient of the outbound message). Ranking the candidate responses may be further based at least in part on respective lengths of the previously transmitted messages.

The electronic device 102 provides one or more of the ranked candidate responses for selection by a user (506). The electronic device 102 may receive a selection of one of the one or more ranked candidate responses, and transmit, responsive to the selection, the selected one of the one or more ranked candidate messages.

As described above, one aspect of the present technology is the gathering and use of data available from various sources to, for example, provide users with candidate responses that may be of interest to them. The present disclosure contemplates that in some instances, this gathered data may include personal information data that identifies user activity on an electronic device with respect to a specific person. Such personal information data can include, for example, identification of user interests, demographic data, temporal-based data, location-based data, or other identifying information.

The present disclosure recognizes that the use of such personal information data, in the present technology, can be used to the benefit of users. For example, the personal information data can be used to deliver candidate responses that are of greater interest to the user. Accordingly, use of such personal information data enables discrete control of the delivered content. Further, other uses for personal information data that benefit the user are also contemplated by the present disclosure.

The present disclosure further contemplates that, when the personal information data is not stored exclusively on the user's device, the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. As is described herein, the collected personal information is only stored on the user's own devices, with the exception of temporarily caching some data on a server for transport purposes.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, users can select not to provide content of messages for generating candidate responses. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information, or publically available information.

FIG. 6 illustrates an electronic system 600 with which one or more implementations of the subject technology may be implemented. The electronic system 600 can be, and/or can be a part of, one or more of the electronic devices 102, 204, and/or one or the server 208 shown in FIG. 1. The electronic system 600 may include various types of computer readable media and interfaces for various other types of computer readable media. The electronic system 600 includes a bus 608, one or more processing unit(s) 612, a system memory 604 (and/or buffer), a ROM 610, a permanent storage device 602, an input device interface 614, an output device interface 606, and one or more network interfaces 616, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a floppy disk, flash drive, and its corresponding disk drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to one or more networks and/or to one or more network nodes, such as the electronic device 102 shown in FIG. 1, through the one or more network interface(s) 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A device, comprising:
at least one processor; and
a memory including instructions that, when executed by the at least one processor, cause the at least one processor to:
determine candidate responses for a received message based at least in part on a determined category of the received message;
rank the candidate responses based at least in part on input modalities utilized to input messages previously transmitted via the device, at least one of the previously transmitted messages comprising at least one of the candidate responses; and
provide one or more of the ranked candidate responses for selection by a user.

2. The device of claim 1, wherein information indicative of the input modalities utilized to input messages previously transmitted via the device is stored exclusively on the device.

3. The device of claim 1, wherein the input modalities comprise at least one of: a dictation input mode, a handwriting input mode, or a suggested response selection input mode.

4. The device of claim 3, wherein ranking the candidate responses is further based at least in part on respective frequencies of user selection of the candidate responses in the suggested response selection input mode.

5. The device of claim 4, wherein ranking the candidate responses is biased with respect to the respective frequencies based on a time decay function.

6. The device of claim 1, wherein the instructions further cause the at least one processor to:
receive a selection of one of the one or more ranked candidate responses; and
transmit, responsive to the selection, the selected one of the one or more ranked candidate responses.

7. The device of claim 1, wherein ranking the candidate responses is further based at least in part on a sender of the received message.

8. The device of claim 1, wherein ranking the candidate responses is further based at least in part on respective lengths of the previously transmitted messages.

9. A computer program product comprising code stored in a tangible computer-readable storage medium, the code comprising:
code to determine candidate responses for a received message based at least in part on a sender of the received message;
code to rank the candidate responses based at least in part on input modalities utilized to input messages previously transmitted via a device, at least one of the previously transmitted messages comprising a respective at least one of the candidate responses; and
code to provide one or more of the ranked candidate responses for selection by a user.

10. The computer program product of claim 9, wherein information indicative of the input modalities utilized to input messages previously transmitted via the device is stored exclusively on the device.

11. The computer program product of claim 9, wherein the input modalities comprise at least one of: a dictation input mode, a handwriting input mode, or a suggested response selection input mode.

12. The computer program product of claim 11, wherein ranking the candidate responses is further based at least in part on respective frequencies of user selection of the candidate responses in the suggested response selection input mode.

13. The computer program product of claim 12, wherein ranking the candidate responses is biased with respect to the respective frequencies based on a time decay function.

14. The computer program product of claim 9, the code further comprising:
code to receive a selection of one of the one or more ranked candidate responses; and
code to transmit, responsive to the selection, the selected one of the one or more ranked candidate responses to the sender of the received message.

15. The computer program product of claim 9, wherein ranking the candidate responses is further based at least in part on respective lengths of the previously transmitted messages.

16. A method, comprising:
determining candidate messages for sending by a device;
ranking the candidate messages based at least in part on input modalities utilized to input messages previously transmitted via the device, at least one of the previously transmitted messages comprising a respective at least one of the candidate messages; and
providing one or more of the ranked candidate messages for selection by a user.

17. The method of claim 16, wherein the candidate messages are for responding to a received message, and wherein determining the candidate messages is based at least in part on a determined category of the received message.

18. The method of claim 16, wherein information indicative of the input modalities utilized to input messages previously transmitted via the device is stored exclusively on the device.

19. The method of claim 16, wherein the input modalities comprise at least one of: a dictation input mode, a handwriting input mode, or a suggested response selection input mode.

20. The method of claim 19, wherein ranking the candidate messages is further based at least in part on respective frequencies of user selection of the candidate messages in the suggested response selection input mode.
